(19) United States
(12) Patent Application Publication
(10) Pub. No.: US 2022/0318499 A1
(43) Pub. Date: Oct. 6, 2022

(54) ASSISTED ELECTRONIC MESSAGE COMPOSITION

(71) Applicant: Microsoft Technology Licensing, LLC, Redmond, WA (US)

(72) Inventors: Qiang XIAO, Palo Alto, CA (US); Haichao WEI, Santa Clara, CA (US); Praveen Kumar BODIGUTLA, Santa Clara, CA (US); Huiji GAO, Sunnyvale, CA (US); Arya G. CHOUDHURY, Sunnyvale, CA (US)

(21) Appl. No.: 17/218,710

(22) Filed: Mar. 31, 2021

(51) Int. Cl. G06F 40/274; G06N 3/04; G06F 40/56; H04L 12/58

(52) U.S. Cl. CPC G06F 40/274; G06N 3/04; G06F 40/56; H04L 51/046

(57) ABSTRACT

Computer-implemented machine learning-based techniques for assisted electronic message composition in a vertical messaging context. The vertical messaging context may be any electronic messaging context in which senders repetitively compose electronic messages to send to recipients where the messages are not identical but nonetheless have common tone, sentiment, content, and structure. The techniques assist users that compose electronic messages in a particular vertical messaging context in composing those messages quickly, with few or no grammatical errors, and with a likelihood of being positively received by the recipients of the messages.

### TECHNICAL FIELD

Computer-implemented machine learning-based techniques are disclosed. The disclosed techniques pertain generally to electronic messaging. The electronic messaging can include, for example, e-mail messaging, text messaging, and in-app messaging. More specifically, the disclosed techniques pertain to computer-implemented techniques for assisted electronic message composition.

### BACKGROUND

Computer-assisted electronic message composition has enjoyed greater adoption by computer users in recent years. Current assistants use machine learning to suggest completions to partially entered sentences. The suggestions are made as the user is typing the electronic message. Assistants enable users to save message composition time by reducing repetitive writing and the chance of spelling and grammatical errors.

One drawback to current assistants is their general-purpose nature. To support a wide variety of different messaging contexts, these assistants typically consume a large amount of computing resources. For example, substantial CPU cycles and computer storage media can be consumed training machine learning models and when using the models to make inferences. The present invention addresses this and other issues.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1A, FIG. 1B, FIG. 1C, FIG. 1D, FIG. 1E, FIG. 1F, FIG. 1G, FIG. 1H, FIG. 1J,

FIG. 1K, FIG. 1L illustrate an example of the disclosed techniques for assisted electronic message composition from the perspective of a user composing an electronic message.

FIG. 2A depicts a scoring pipeline for assisted electronic message composition.

FIG. 2B depicts an inference pipeline for assisted electronic message composition.

FIG. 3 depicts a hierarchical attention network for assisted electronic message composition.

FIG. 4 depicts a wide and deep learning model for assisted electronic message composition.

FIG. 5 depicts a two-tower model for assisted electronic message composition.

FIG. 6 is a block diagram of an example basic computing device for use in an implementation of the disclosed techniques.

FIG. 7 depicts an example basic software system for controlling the operation of the device of FIG. 6.

### DETAILED DESCRIPTION

In the following description, for the purposes of explanation, numerous specific details are set forth to provide a thorough understanding of the disclosed techniques. It will be apparent, however, that the disclosed techniques may be practiced without these specific details. In other instances, well-known structures and devices are shown in block diagram form to avoid unnecessarily obscuring the disclosed techniques.

### General Overview

Computer-implemented techniques for assisted electronic message composition in a vertical messaging context are disclosed. The vertical messaging context may be any electronic messaging context in which senders repetitively compose electronic messages to send to recipients where the messages are not identical but nonetheless have common tone, sentiment, content, and structure. For example, the vertical messaging context may be a recruiting messaging context. A recruiting messaging context generally involves recruiters for unfilled employment positions composing and sending electronic messages to candidates with the potential to fill the positions. Electronic messages that a recruiter composes to send to potential candidates typically all begin with a greeting, are friendly but professional in tone, express a positive sentiment about a job opening and the candidate's qualifications, provide details about the position, and end with a request of the candidate to reply to the message if the candidate is interested in the job opening. The techniques disclosed herein assist recruiters and other types of users that compose electronic messages in a particular vertical messaging context to compose those messages quickly, with few or no grammatical errors, and with a likelihood of being positively received by the recipients of the messages.

The techniques generally involve suggesting grammatical text units to users composing electronic messages as the users are composing the electronic messages. The grammatical text units, or just “grammatical units,” are suggested for inclusion in the body of the electronic message being composed. Preferably, a suggested grammatical unit is a sentence or a clause that is coherent by itself. Because sentences and clauses have coherent meaning by themselves, the probability of making an incoherent suggestion or a grammatically incorrect suggestion is reduced or eliminated by suggesting them.

In another aspect, the techniques improve the user-computer interface by saving the user from entering text characters using a text character input device such as a physical keyboard or virtual keyboard displayed on a touch sensitive display. Instead of the user entering each text character of a sentence or a clause, the user can select a suggested coherent unit to include in the electronic message body with a single keystroke, a single touch gesture, or a single pointing device “click,” thereby saving the user from tedious user input tasks.

In addition to the benefit to users when composing electronic messages, the techniques provide technical benefits to a computing system implementing the techniques. In one aspect, the techniques increase the electronic security of user information by learning a machine learning model from a type of coherent unit that has been stripped of certain named entities. Such coherent units that have been stripped of certain named entities or that did not contain the certain named entities to begin with are referred to herein as “standard text units,” or just “standard units.” Because the model is learned from standard units, the named entities do not need to be stored or duplicated as part of the training data set used by the machine learning process to learn the model. Despite learning the model based on standard units, the techniques can suggest to user a coherent unit that contains named entities. This is done through a late binding of named entities to standard units suggested by the model. It is considered late binding in that the named entities replace placeholders in suggested standard units before the units with the placeholders replaced with the named entities are suggested to the user but after the standard unit is suggested by the model.

In yet another aspect, the techniques reduce the computing system latency and computing resources consumed for assisted message composition. One way that a reduction in latency and computing resource consumption is achieved is by suggesting sentences or clauses, as opposed to phrases, words, or morphemes. By doing so, fewer suggestions are made for a message being composed. For example, a system that recommends words may make multiple suggestions for each sentence or clause being composed where each suggestion is a suggested next word to add to the sentence or clause. For each such suggestion, computing resources (e.g., CPU and memory) are consumed evaluating candidate words. With the techniques disclosed herein that suggest sentences or clauses, an order of magnitude fewer suggestions, for example, may be made and hence fewer computing resources required.

These and other benefits of the disclosed techniques will now be described in greater detail with reference to the drawings.

### Assisted Composition Example

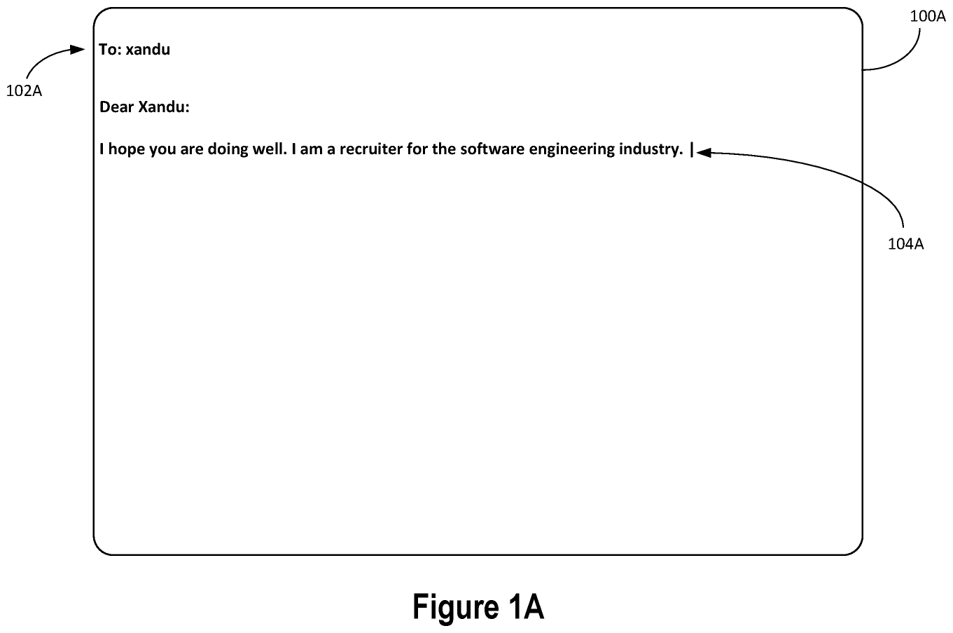

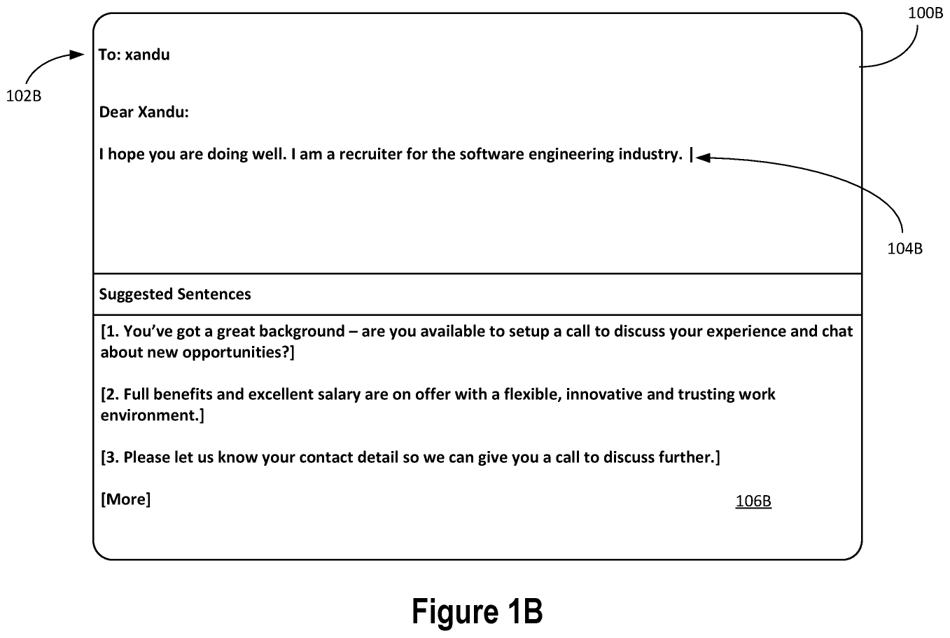

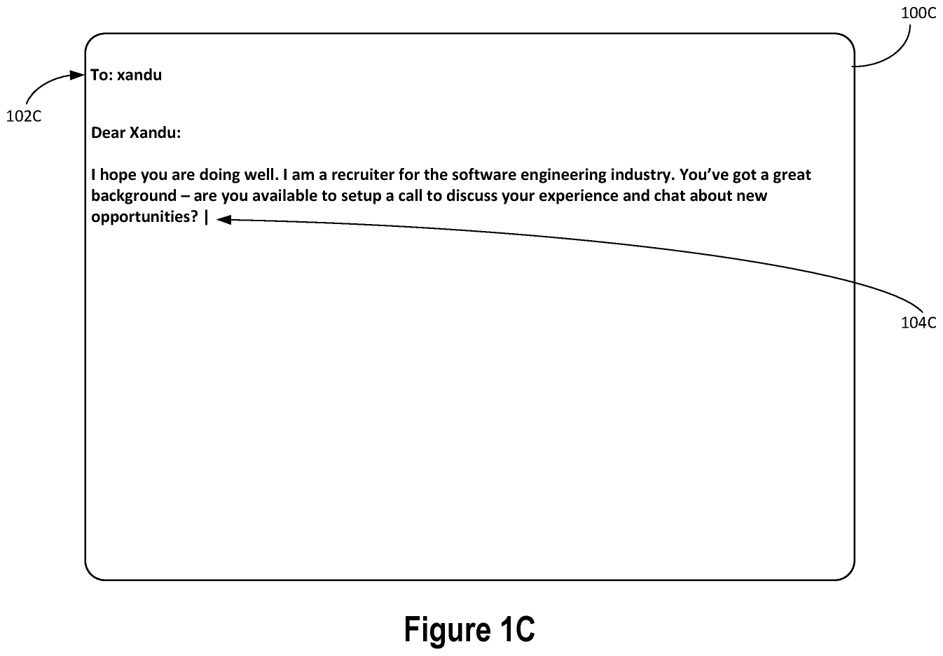

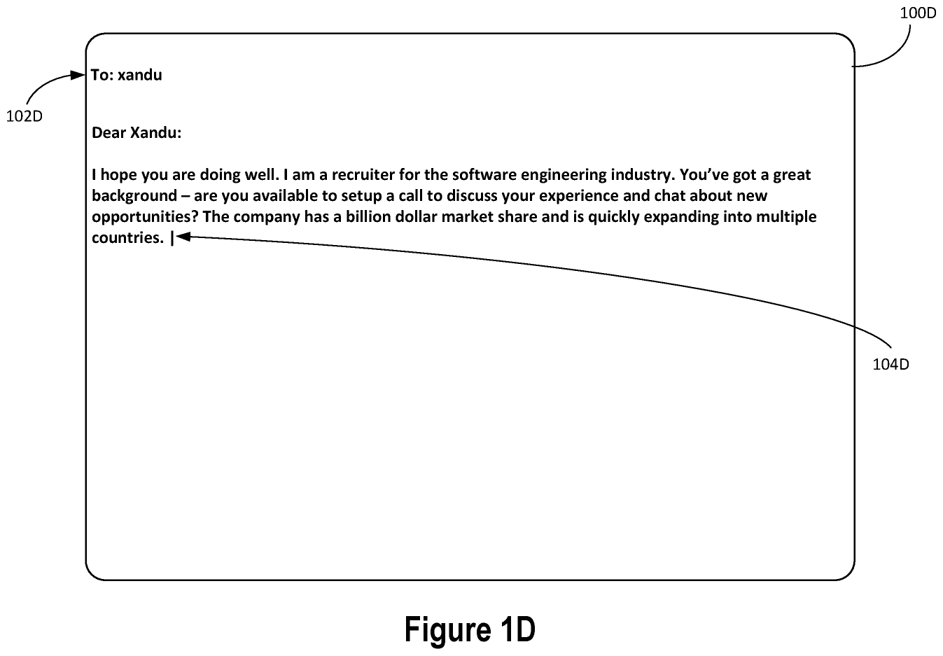

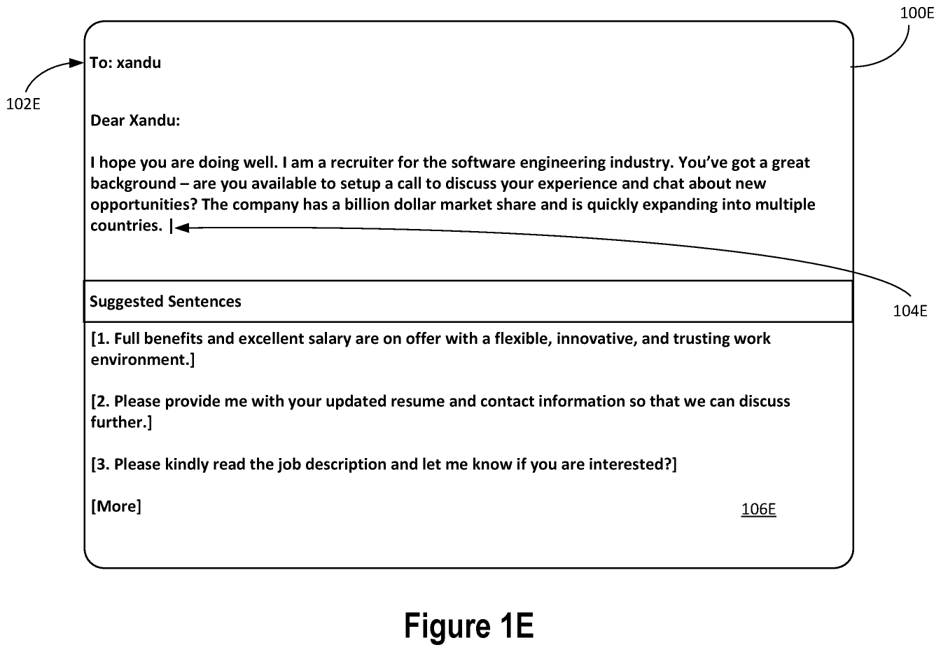

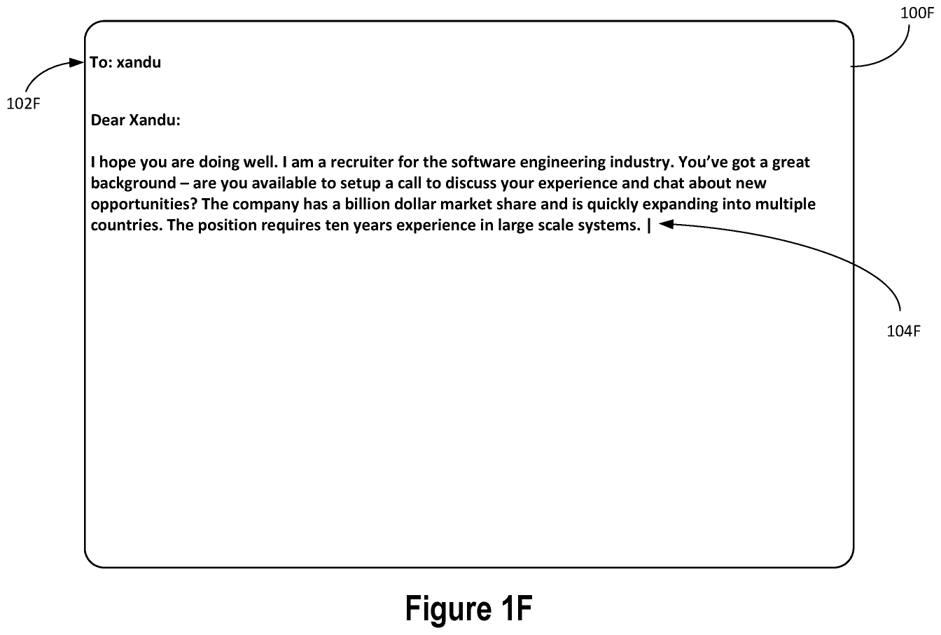

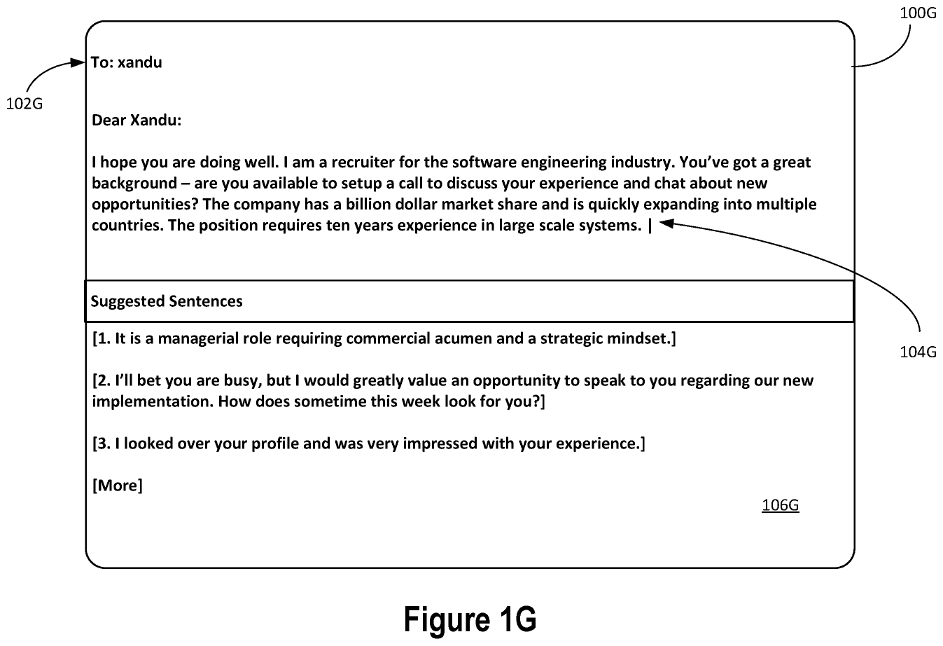

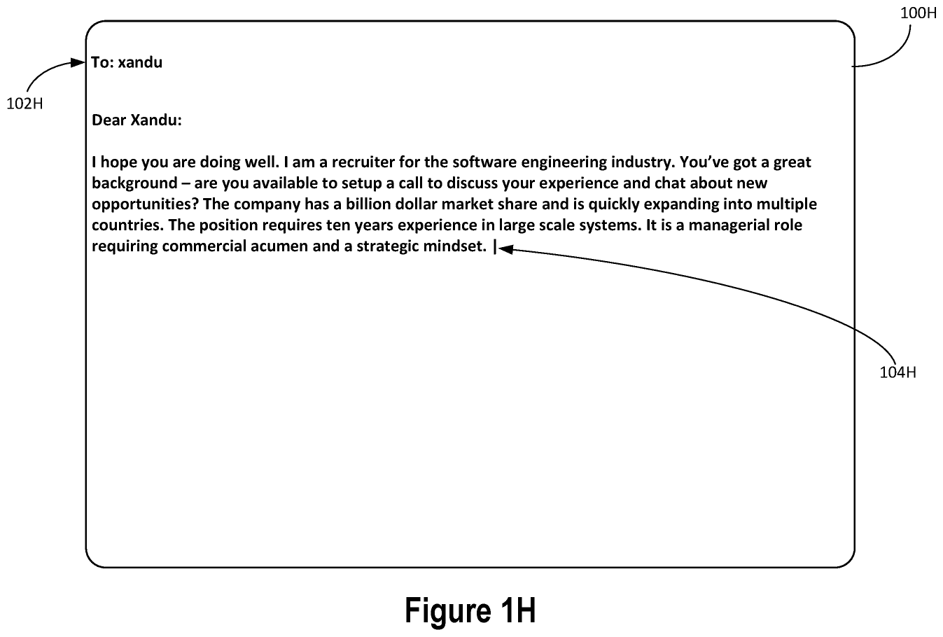

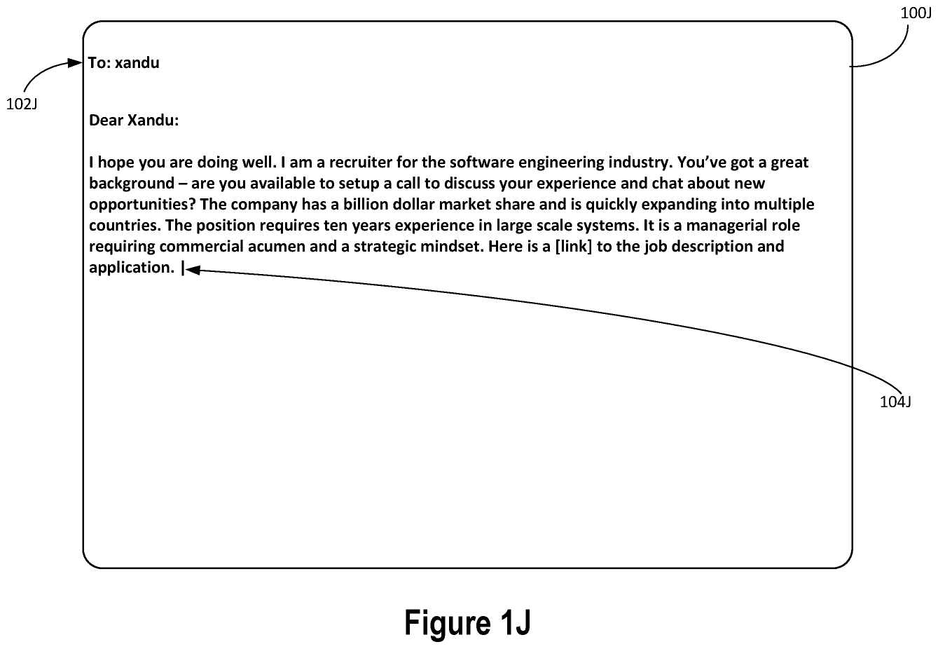

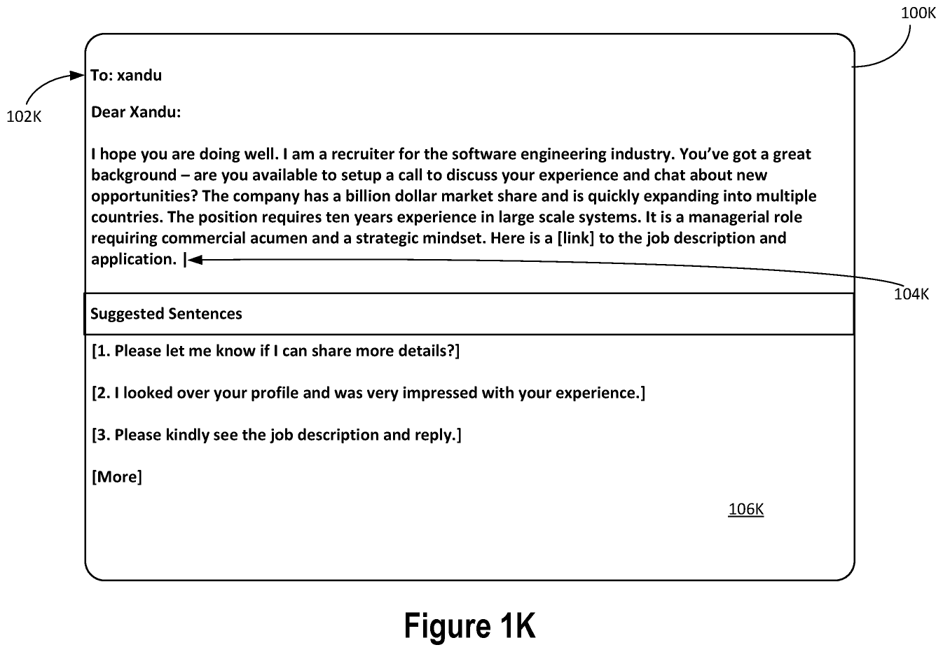

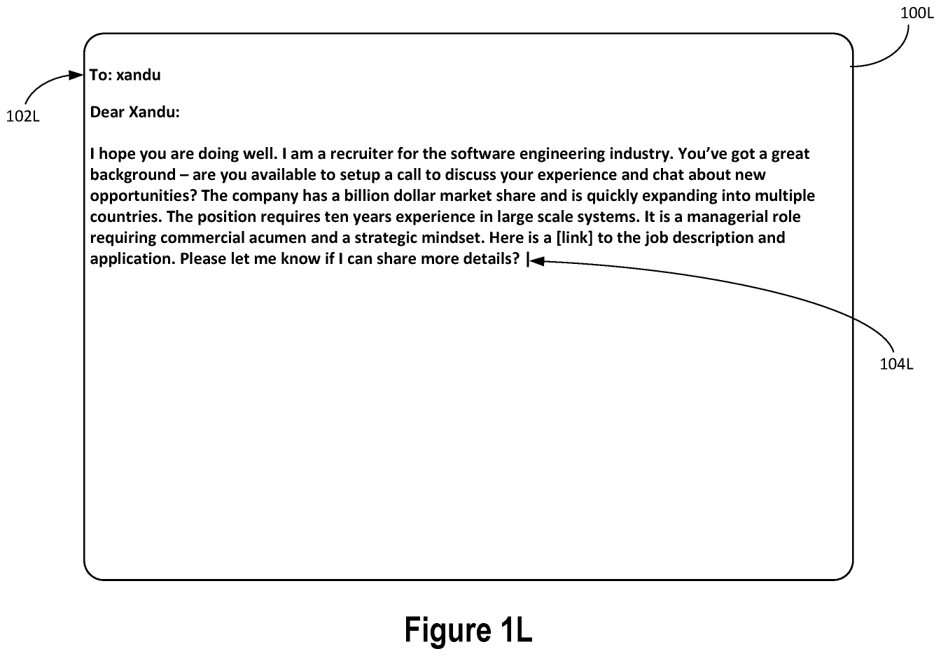

FIG. 1A-1K illustrate an example of the disclosed techniques from the perspective of a user composing an electronic message. In the example, the user is a recruiter for an unfilled employment position that the recruiter is seeking to match with a qualified candidate. While the techniques may be used in the job recruiting context, the techniques are more generally applicable to other messaging contexts. The techniques are especially applicable to messaging contexts where a sender composes multiple electronic messages for different recipients where each message is directed to one recipient and personalized for that recipient but where there is a common theme, topic, or prose structure among the messages.

Other messaging contexts to which the techniques might be applied in addition to or instead of the job recruiting context include, but are not limited to, a learning recruiting context where affiliates of an online school or an online course ask qualified candidate students to consider enrolling in the online school or the online course, a political endorsement context where associates of a political candidate are seeking support for the political candidate from constituents that might view the candidate favorably, a volunteer recruiting context where a coordinator is seeking volunteers to support a project or cause that might be of particular interest to the volunteers, a marketing context where a marketer of a good or service is promoting the good or service to potential customers that might be especially interested in the good or service, a sales context where a salesperson makes a personalized sales pitches in e-mails sent to potential customers, or other messaging context where a sender is composing and sending many like, and potentially personalized messages, to different recipients. Thus, while examples herein are provided in the recruiting messaging context, the disclosed techniques are not so limited and may be used in other vertical messaging contexts.

FIG. 1A depicts graphical user interface (GUI) 100A. GUI 100A may be displayed at a personal computing device. For example, GUI 100A may be presented on a video display screen of a desktop computer, a laptop computer, a tablet computer, or a mobile phone. GUI 100A allows a user of the device to compose an electronic message. In this example, the electronic message being composed is addressed to an intended recipient identified by example user handle 102A of the intended recipient. Example user handle 102A “Xandu” may identify a user of a social media application platform, for example.

While the techniques may be used to assist composition of electronic mail messages (e.g., “email” or “e-mail” messages), the techniques may be used to assist senders in composition of other types of electronic messages including, but not limited to, private messages. The term “private message” is intended to encompass any electronic message other than email messages that are private to a sender and a recipient of the private message. Historically, private messages were sent via Internet Relay Chat (IRC) applications. More recently, online social media platforms support private messaging functionality between users of the platform. Private messages go by many alternative names including, but not limited to, instant messages, direct messages (DMs), chats, personal messages, etc. Email and private electronic messaging mechanisms may use electronic mail addresses to identify intended recipients. However, for private electronic messages, other recipient identification or addressing mechanisms may be used to identify an intended recipient such as user identifiers, usernames, account identifiers, profile identifiers, user handles, etc.

In the example of FIG. 1A, the user has input some text of the electronic message intended for the recipient addressable at the example user handle “Xandu”. User handle 102B may identify a user of a social media application platform, for example. The text is input manually or by means other than by selecting coherent units suggested according to the techniques disclosed herein. For purposes of providing a clear example, the term “selected text” is used to refer to text of the electronic message that is input by the user selecting coherent units suggested according to the techniques disclosed herein, and the term “user text” is used to refer to text of the electronic message that is input otherwise. The techniques disclosed herein allow a user to compose an electronic message using selected text in addition to, and potentially instead of, inputting user text. A text input cursor is located 104A after the user text.

FIG. 1B depicts GUI 100B that is displayed at the personal computing device after GUI 100A is displayed at the personal computing device. User handle 102B corresponds to user handle 102A of GUI 100A and text input cursor location 104B corresponds to text input cursor location 104A of GUI 100A. In addition, suggested sentences panel 106B is displayed as part of GUI 100B. Panel 106B presents three sentences as selectable options for insertion at text input cursor location 104B. In this example, three sentences are presented as options. However, fewer than three or more than three sentences can be presented as options. Panel 106B includes a selectable “More” option that when selected by the user may present additional sentences for selection in addition to ones already presented in panel 106B.

Suggested sentences panel 106B may be automatically displayed as the user inputs user text. For example, panel 106B may be automatically displayed as the user finishes or has finished inputting a sentence or clause of user text. Alternatively, GUI 100B may provide a selectable button, menu item, or the like (not shown) that, when selected by the user, causes panel 106B to be presented. Thus, the techniques disclosed herein encompass both automatically suggesting coherent units to a user composing an electronic message and suggesting coherent units to a user on-demand in response to a user input request for a suggestion.

Since the suggestions made according to the techniques disclosed herein are coherent units such as complete sentences or complete clauses, an automatic or on-demand suggestion may be made by presentation of a suggestion panel (e.g., 106B) in a graphical user interface after the user has input user text that completes a sentence or clause. For example, in the example of GUI 100B, panel 106B may presented after the user finishes entering the sentence “I am a recruiter for the software engineering industry.” The suggestion may be one or more coherent units that are suggestions to the user to follow the coherent unit that the user just finished entering.

FIG. 1C depicts GUI 100C that is displayed at the personal computing device after GUI 100B is displayed at the personal computing device. User handle 102C corresponds to user handle 102B of GUI 100B. GUI 100C reflects the electronic message composition after the user has provided user input that selects suggested coherent unit option 1 presented in panel 106B of GUI 100B. The user may have selected option 1 using a convenient user input mechanism such as by keyboard keystroke, by touch gesture, or by a “click” (e.g., mouse click) of a pointing device. Notably, selection of option 1 takes fewer keystrokes, touch gestures, or clicks than if selecting each individual text character of the coherent unit selected. For example, selection of option 1 may take only a single keystroke, touch gesture, or click. As a result of the user selection, the selected text is automatically inserted into the text body of the electronic message starting at text input cursor location 104B of FIG. 100B when option 1 was selected. After the automatic insertion of the selected text, the text input cursor has automatically moved from location 104B to location 104C following the suggested text. The user may continue inputting user text from new text input cursor location 104C.

FIG. 1D depicts GUI 100D that is displayed at the personal computing device after GUI 100C is displayed at the personal computing device. User handle 102D corresponds to user handle 102C of FIG. 1C. In GUI 100D, the user has input additional user text starting from text input cursor location 104C in GUI 100C. After the additional user text is input, the text input cursor 104D has moved to location 104D.

FIG. 1E depicts GUI 100E that is displayed at the personal computing device after GUI 100D is displayed at the personal computing device. User handle 102E corresponds to user handle 102D and text input cursor location 104E corresponds to text input cursor location 104D of GUI 100D. Suggested sentences panel 106E is displayed as part of GUI 100E. Panel 106E presents three sentences as options selectable by the user for insertion at text input cursor location 104E. If the user does not wish to select any of the presented sentence options from panel 106E, the user may cause panel 106E to no longer be displayed by inputting user text at text input cursor location 104E or by otherwise taking a user input action that indicates that the user does not wish to select one of the sentences offered (e.g., by dismissing panel 106E without selecting a sentence option).

FIG. 1F depicts GUI 100F that is displayed at the personal computing device after GUI 100E is displayed at the personal computing device. User handle 102F corresponds to user handle 100E of GUI 100E. GUI 100F reflects the electronic message composition after the user has selected suggested coherent unit (sentence) option 1 presented in panel 106E of GUI 100E. As a result of the user selection, the selected text is automatically inserted into the text body of the electronic message starting at the location corresponding to text input cursor location 104E of GUI 100E. After the automatic insertion of the selected text, text input cursor has automatically moved from location 104E to location 104F.

FIG. 1G depicts GUI 100G that is displayed at the personal computing device after GUI 100F is displayed at the personal computing device. User handle 102G corresponds to user handle 102F and text input cursor location 104G corresponds to text input cursor 104F of GUI 100F. Suggested sentences panel 106G is displayed as part of GUI 100G. Panel 106G presents three sentences as options selectable by the user for insertion at text input cursor location 104G.

FIG. 1H depicts GUI 100H that is displayed at the personal computing device after GUI 100G is displayed at the personal computing device. User handle 102H corresponds to user handle 100H of GUI 100H. GUI 100H reflects the electronic message composition after the user has selected suggested coherent unit (sentence) option 1 presented in panel 106G of GUI 100G. As a result of the user selection, the selected text is automatically inserted into the text body of the electronic message starting at the location corresponding to text input cursor location 104G of GUI 100G. After the automatic insertion of the selected text, text input cursor has automatically moved from location 104G to location 104H.

FIG. 1J depicts GUI 100J that is displayed at the personal computing device after GUI 100C is displayed at the personal computing device. User handle 102J corresponds to user handle 102H of FIG. 1H. In GUI 100J, the user has input additional user text starting from text input cursor location 104H in GUI 100H. After the additional user text is input, the text input cursor 104J has moved to location 104J.

FIG. 1K depicts GUI 100K that is displayed at the personal computing device after GUI 100J is displayed at the personal computing device. User handle 102K corresponds to user handle 102J and text input cursor location 104K corresponds to text input cursor 104J of GUI 100J. Suggested sentences panel 106K is displayed as part of GUI 100K. Panel 106K presents three sentences as options selectable by the user for insertion at text input cursor location 104K.

FIG. 1L depicts GUI 100L that is displayed at the personal computing device after GUI 100K is displayed at the personal computing device. User handle 102L corresponds to user handle 100K of GUI 100K. GUI 100OL reflects the electronic message composition after the user has selected suggested coherent unit (sentence) option 1 presented in panel 106K of GUI 100K. As a result of the user selection, the selected text is automatically inserted into the text body of the electronic message starting at the location corresponding to text input cursor location 104K of GUI 100K. After the automatic insertion of the selected text, text input cursor has automatically moved from location 104K to location 104L.

FIG. 1A-1K illustrates how a user may be assisted in composing an electronic message in a vertical messaging context. Here, the vertical messaging context is recruiting for open employment positions. Each of the suggestions of GUIs 100B, 100E, 100G, and 100K are made considering any existing user text and suggested text of the electronic message being composed. As a result, suggestions that are coherent with the existing text are made. The suggestions also save the user from typing by allowing the user to insert complete sentences or clauses with a single keystroke, touch gesture, or pointing device click. Because the suggested grammatical units are complete sentences and clauses, they can be verified for grammatical correctness independent of any electronic message for which they are suggested and prior to being suggested. As a result, fewer or no grammatical errors are introduced into the electronic message being composed when the user selects a suggested coherent unit.

Prior approaches to the technical problem of assisted electronic message composition for vertical messaging contexts have attempted to address the problem with a fixed template approach. With the fixed template approach, an entire electronic message body is suggested. The present approach eschews whole message templates for a more flexible approach that suggests sentences and clauses as the user is composing the electronic message. The approach is more flexible because it allows the user to pick and choose which suggestions to adopt at the level of individual sentences or clauses as opposed to taking on the cognitive burden of deciding which template is appropriate to use before beginning the message composition task. Instead, the user can simply begin typing an introduction for the message and receive, just-in-time, suggestions for continuing the composition in terms of the next sentence or clause. The user can ignore a suggestion and continue to input user text until the system recommends a suggestion that the user likes. If the user decides a suggestion is useful, the user can confirm the suggestion for inclusion in the message being composed and then continue inputting user text. The user may continue to receive suggestions as the user inputs user text in the message body. Thus, the techniques improve the human-computer interface in a way that does require the user to fundamentally change the message composition task, but at the same time assists the user in more efficiently and more effectively composing electronic messages.

### Scoring and Inference Pipelines

The techniques encompass a machine learning-based “scoring” data processing pipeline and a machine learning-based “inference” data processing pipeline. In the scoring pipeline, a set of “salient” text units are identified from a set of electronic messages. A salient text unit is a coherent text unit of an electronic message that is determined by the scoring pipeline to be an especially important or an especially noticeable coherent text unit of the electronic message. For example, a salient unit may be a coherent unit of an electronic message that the scoring pipeline determines is most likely to contribute to acceptance of the electronic message by a recipient.

In the inference pipeline, salient units are selected for suggestion to users while the users are composing electronic messages. The selections are made by the inference pipeline based on the current text of messages being composed. A selected salient unit may have a categorical placeholder for a named entity. For example, a selected salient unit might be “I came across your online professional profile and think your [Skill] background is a great fit for a [Position] at [Company] in [Location].”. Here, the text tokens “[Skill],” “[Position],” “[Company],” and “[Location]” are categorical named entity placeholders. If a selected salient unit has a categorical named entity placeholder, the placeholder is replaced in the salient unit with a named entity to form a coherent unit that is suggested to the user. The named entity may be obtained by the inference pipeline from user profile information for the sender or the intended recipient of the message. The named entity obtained may depend on the vertical messaging context. For example, if the vertical messaging context is recruiting, then the named entity might be a college or university of the recipient, an industry in which the sender recruits, a skill of the recipient, a title of the open employment position, a geographical location of the employment opportunity, etc. Returning to the example earlier in this paragraph, the categorical placeholders in the selected salient unit might be replaced as so: “I came across your online professional profile and think your software engineering background is a great fit for a technical software lead at Initech in Austin, Tex.”

### Scoring Pipeline

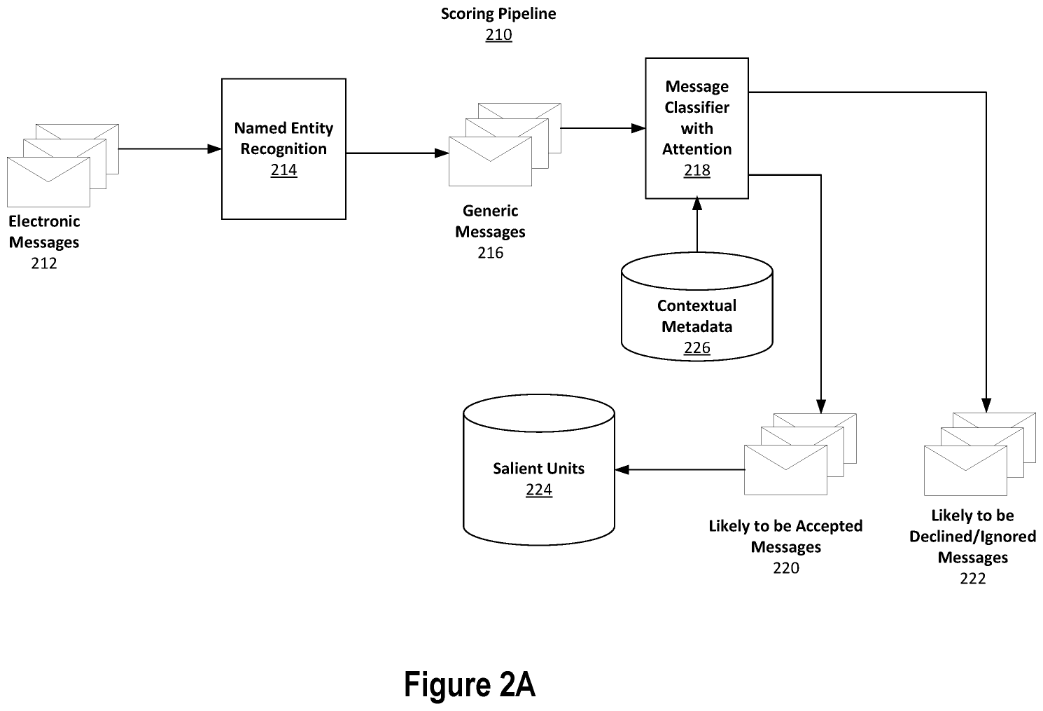

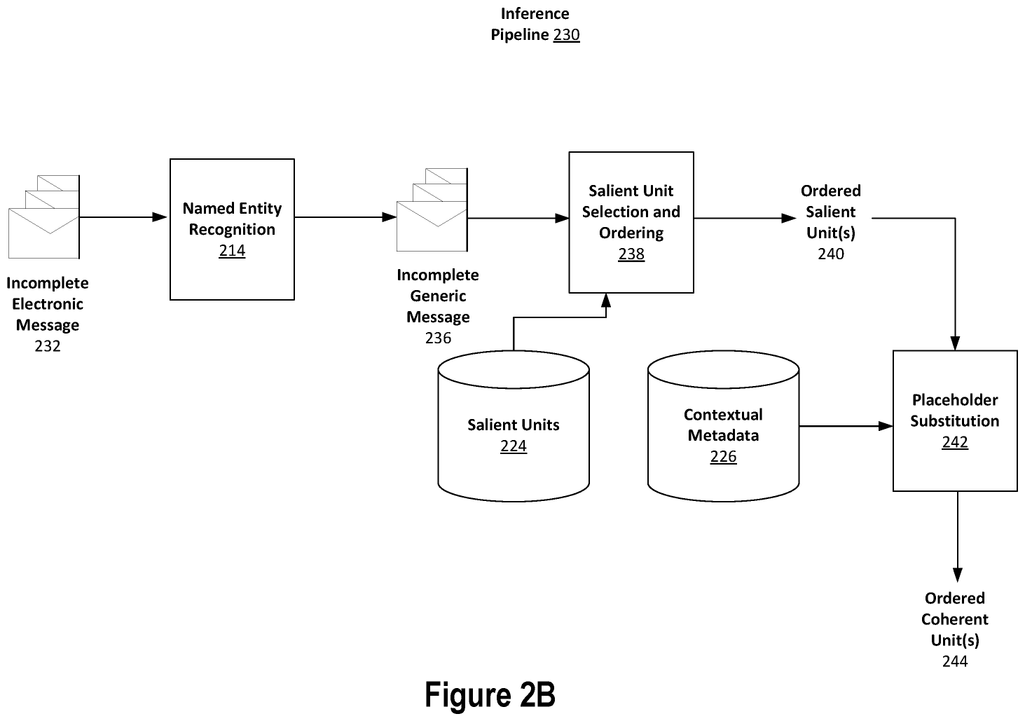

Turning first to the scoring pipeline of FIG. 2A, the scoring pipeline involves processing a set of electronic messages in a particular vertical messaging context. The set 212 of messages may include email messages, private messages, or other types of electronic message that contain text content. While set 212 may contain a heterogeneous mix of different types of electronic messages (e.g., a combination of email messages and private messages), set 212 may contain just one type of electronic messages (e.g., all private messages).

At a minimum, each electronic message in set 212 comprises text content such as text in prose form. An electronic message in set 212 may also be associated with a sender identity and a recipient identity. The sender identity can be an email address, a username, a user profile identifier, a user handle, a phone number, or other user moniker or identifier that an electronic messaging system uses as the identity of the sender of the electronic message. The electronic messaging system may be an email system, an instant messaging system, a text messaging system, a personal or direct messaging system, or other type of messaging system. Likewise, the recipient identifier can be an email address, a username, a user profile identifier, a user handle, a phone number, or other user moniker or user identifier that the electronic messaging system uses as the identity of the recipient of the electronic message.

Each of messages in set 212 may be electronic messages that were delivered by an electronic messaging system. The sender of an electronic message in set 212 may be taken as an identity of an entity (e.g., a person) that that the electronic messaging system determines to have sent the electronic message such as, for example, as recorded in log files. The recipient of an electronic message in set 212 may be taken as an identity of an entity to which the electronic message was addressed and to which the electronic message system delivered the electronic message such as, for example, as recorded in log files. While some or all of messages 212 may be electronic messages that were actually delivered by an electronic messaging system between actual senders and actual recipients, some or all of messages 212 may be computer (synthetically) generated for the purposes of generating salient units 224. For example, a synthetically generated message may be a prototypical example of how to compose a message in the particular vertical messaging context that is likely to be accepted by a recipient.

As indicated, all of messages 212 may belong to the particular vertical messaging context. The particular vertical messaging context may be a recruiting messaging context, for example. However, more generally, the particular vertical messaging context may be any electronic messaging context in which senders repetitively compose electronic messages to send to recipients where the messages are not identical but nonetheless have common tone, sentiment, content, and structure. For example, electronic messages that a recruiter composes to send to potential candidates typically all begin with a greeting, are friendly but professional in tone, express a positive sentiment about a job opening and the candidate's qualifications, provide details about the position, and end with a request of the candidate to reply to the message if the candidate is interested in the job opening.

### Named Entity Recognition

Named entity recognition 214 is applied to electronic messages to identify named entities in set 212 of electronic messages. Identified named entities in electronic messages 212 are replaced with categorical named entity placeholders to produce a set of standard messages 216 that correspond to the set of input messages 212 but with identified named entities replaced with categorical named entity placeholders. The named entities that named entity recognition 214 attempts to identify in electronic messages 212 may vary depending on the particular vertical messaging context. For example, in the recruiting messaging context, identified named entities may include named entities that belong to any of the following named entity categories related to recruiting, a subset of these categories, or a superset thereof:
Full name, last name, first name, etc.
Company name, organization name, business name, etc.
Skill, talent, experience, etc.
Geographic location, city, state, zip code, area code, geographic region, etc.
School, college, university, etc.
Industry, business sector, sub-industry, sub-sector, etc.

A purpose of applying named entity recognition 214 to electronic messages 212 is to produce a standard form of electronic messages 212. For example, electronic messages 212 may include actual electronic message sent by senders to recipients with text content that includes named entities. By removing named entities pertaining to the vertical messaging context from the electronic messages 212, the resulting standard messages 216 can be scored for purposes of identifying salient text units 224 in the standard messages 216 that are standard.

Because the identified salient text units are standard, they are more suitable to be suggested for inclusion in any electronic message composition in the particular vertical messaging context. In contrast, if the identified salient units contained named entities, they may be suitable for only certain electronic messages containing the same or similar named entities. For example, it may not be appropriate to suggest “I am a recruiter for the software industry” to a recruiter that is composing a message to send to a potential candidate in the construction industry, while the standard unit “I am a recruiter for the [Industry]” can be considered as a candidate to suggest to a either a recruiter for the software industry or a recruiter for the construction industry. In this case, the categorical named entity placeholder “[Industry]” can be replaced with the appropriate named entity (e.g., “software industry” or “construction industry”) before the unit is suggested to the recruiter.

Beneficially, the number of coherent text units that are stored as candidates 224 in computer storage media for suggestion is reduced because instead of storing one coherent unit for each distinct named entity, a single standard unit can be stored. This conserves storage media space. For example, instead of storing in computer storage media the two coherent units: (1) “I am a recruiter for the software industry.” and (2) “I am a recruiter for the construction industry,” the single standard unit “I am a recruiter for the [Industry].” can be stored. This also conserves consumption of CPU cycles in the inference pipeline because fewer candidate coherent units need to be considered for possible suggestion to the user. Thus, by storing standard units as part of salient units 224, operation of a computing system implementing of the inference pipeline is improved in terms of both computer storage media consumption and CPU cycle consumption. The effect is that suggestions can be made faster (with less latency) and with greater efficiency (with fewer computing resources consumed).

Generally, named entity recognition 214 performs an information extraction computing task. The task locates and classifies certain named entities mentioned in messages 212 in pre-defined categories such as persona names, organizations, locations, companies, schools, colleges, universities, skills, industries, or other named entity categories suitable for the particular vertical messaging context. A named entity can be a real-world object such as a persona, location, organization, etc., that is denoted with a proper or well-known name, acronym, or initialism. A named entity can be an abstract concept or have a physical existence. More generally, a named entity can be viewed as an instance of a type of entity mentioned in the text of messages 212. Named entity recognition 214 can be implemented using a rule-based approach, a statistical-based approach, a machine learning-based approach, or a combination of these approaches. No particular approach is required. An open-source implementation that may be used for named entity recognition 214 is the spaCy natural language processing system which includes a machine learning-based named entity recognition model. More information on the spaCy system and its named entity recognition model is available on the Internet in the spacy.io domain.

### Message Classification with Attention

Message classifier with attention 218 functions to classify each of standard messages 216 as either: (1) one of messages 220 that has a likelihood of being accepted by a recipient or (2) as one of messages 222 that are more likely to be declined or ignored by the recipient. Here, what is considered acceptance of a message can vary according to the requirements of the particular implementation at hand. Salient units 224 are extracted from likely to be accepted messages 220 based on attention scores generated by classifier 218 for coherent units in likely to be accepted messages 220. The purpose of this is to identify coherent units in standard messages 216 that contribute to messages 220 being likely to be accepted. Those coherent units are then used as salient units 224 to suggest to users composing electronic messages.

Classifier 218 is machine learning based. In general, classifier 218 has two tasks: (a) a classification (labeling) task, and (2) an attention task. As mentioned, for the classification task, classifier 218 determines whether a given message of standard messages 216 should be included in set of likely to be accepted messages 220 or set of likely to be declined/ignored messages 222. For the attention task, classifier 218 determines which coherent units of standard messages 216 contribute to the classification decision.

### Hierarchical Attention Network (HAN)

In an implementation, classifier 218 uses a hierarchical attention network (HAN) to perform the classification and attention task. The HAN captures the hierarchical structure of a message and the context-dependent nature of the relative importance of coherent units in the message and the words that make up those coherent units. About the hierarchical structure of a message, the HAN captures the concept that messages are formed from coherent units and coherent units are formed from words. Regarding the context-dependent nature of coherent units in a message and the words that make up those coherent units, the HAN captures the concepts that different words and coherent units in a message are differently informative and that the same word or coherent unit may have different importance in different message contexts.

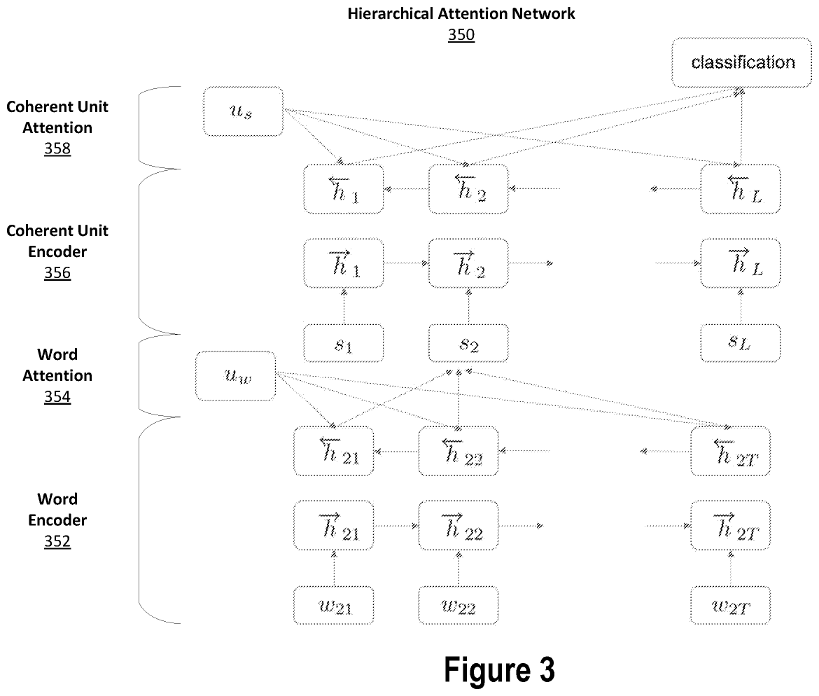

Accordingly, the HAN is configured with two levels of attention mechanisms. One level of attention mechanism is at the word level and the other level of attention mechanism is at the coherent unit level. FIG. 3 depicts an overall architecture of a hierarchical attention network. HAN 350 includes a word sequence encoder 352, a word-level attention layer 354, a coherent unit sequence encoder 356, and a coherent unit-level attention layer 358.

Word sequence encoder 352 and coherent unit sequence encoder 356 may use bidirectional long-term sort-term memory (BiLSTM) units instead of bidirectional gated recurrent (BiGRU) units to handle longer coherent units and longer standard messages more accurately. However, BiGRU units may be used in an implementation of HAN 350. For example, BiGRU units may be used instead of BiLSTM units to reduce the time and computing resources (e.g., CPU and memory) consumed training HAN 350 and to reduce the time and computing resources (e.g., CPU and memory) consumed by HAN 350 for classifying standard messages 216 with attention. Generally, BiLSTM units consume more computing resources for training and inference than BiGRU units due to the three-gate structure of a BiLSTM unit versus the two-gate structure of BiGRU units.

A standard message in standard messages 216 may contain one or more coherent units. Each coherent unit may contain one or more words. HAN 350 is configured to project the standard message into a vector representation. The standard message is then classified by HAN 350 based on the vector representation as either belonging to likely to be accepted messages 220 or belonging to likely to be declined/ignored messages 222.

For each coherent unit of a standard message, word sequence encoder 352 is configured to embed the words of the coherent unit. Word encoder 352 embeds the words to vectors through an embedding matrix. A bidirectional GRU unit or a bidirectional LSTM unit may be used to obtain annotations of the words by summarizing information from both directions for words, and therefore incorporate the contextual information in the annotation. A bidirectional GRU unit or a bidirectional LSTM unit contains a forward unit and a backward unit. The forward unit reads the coherent unit forward from the first word to the last word. The backward unit reads the coherent unit backwards from the last word of the coherent unit to the first word. An annotation is obtained for a given word of the coherent unit by a concatenation of the forward hidden state for the word and the backward hidden state for the word. The annotation summarizes the information of the entire coherent unit centered around the given word. Pre-generated word embeddings may be directly used for the words of the coherent unit. Alternatively, word embeddings may be learned using a GRU or LSTM to derive the word embeddings from the characters of the words.

Not all words of a coherent unit may contribute equally to the representation of the coherent unit meaning. As such, HAN 350 may use an attention mechanism to extract the words that are important to the meaning of the coherent unit. Representations of the informative words may then be aggregated to form a coherent unit vector. Specifically, a word annotation generated by word encoder 352 for a word of a coherent unit may be fed by word attention layer 354 through a multilayer perceptron to obtain a hidden representation of the word annotation. Word attention layer 354 may then determine a normalized importance weight for the word through a softmax function based on measuring the importance of the word as the similarity of the hidden representation of the word annotation with a word-level context vector. The word-level context vector represents a fixed query over the words of the coherent unit that asks, in essence: what is the informative word of the coherent unit? During training of HAN 350, the word-level context vector may be randomly initialized and jointly learned during the training of HAN 350.

Coherent unit sequence encoder 356 operates like word encoder 352 but at the coherent unit level instead of at the word level. In particular, coherent unit encoder 356 uses a bidirectional GRU or a bidirectional LSTM to encode the coherent unit vectors generated by word attention layer 354 both forwards and backwards. The forward and backwards encodings for a coherent unit are then concatenated to generate an annotation for the coherent unit much like word encoder 352 generates an annotation for a word of a coherent unit. This concatenation is done for each coherent unit to generate an annotation for each coherent unit of the standard message.

Coherent unit attention layer 358 uses an attention mechanism and a coherent unit-level context vector to reward coherent units of a standard message that are clues to the correct classification of the standard message. The coherent unit-level context vector is used to measure the importance of the coherent units of the standard message. The result is a message vector that summarizes all the information of coherent units in the standard message. During training of HAN 350, the coherent unit-level context vector may be randomly initialized and jointly learned during the training of HAN 350.

By processing each standard message of standard messages 216 through word encoder 352, word attention 354, coherent unit encoder 356, and coherent unit attention 358, HAN 350 generates a message vector for each standard message of standard messages 216. The message vector for a standard message is a high-level representation of the standard message and can be used as features for message classification. The message vector for a message comprises attention scores for the coherent units of the message, one attention score for each coherent unit.

During training of HAN 350, a negative log likelihood of the correct labels (e.g., “accepted” or “declined/ignored”) can be used as the training loss. Here, for purposes of labeling training examples as “accepted” or “declined/ignored,” what is considered acceptance may vary according to the requirements of the particular implementation at hand. No particular acceptance criterion or criteria is required. However, in general, accepting a message, as opposed to declining or ignoring a message, means that the recipient took an action with respect to the message that indicates that the recipient might be willing to continue a conversation with the sender of the message with regard to the subject matter of the message. For example, any of the following may be considered as acceptance of a message by a recipient of the message:
The recipient opens the message.
The recipient opens and views the message for at least a threshold amount of time.
The recipient replies to the message.
The recipient replies to the message where the text of the reply message (e.g., a determined by a machine learning classifier) indicates that the recipient positively received the sender's message. For example, in the recruiting context, the reply message may contain text expressions such as “I'm interested,” “I would like to learn more,” or “give me a call” that indicate that the recipient positively received the message.

HAN 350 may be trained on a set of standard messages (not depicted). When training HAN 350 and when using HAN 350 after training for message classification of standard messages 216, each message may be parsed by named entity recognition 214 into coherent units and each coherent unit may be tokenized by named entity recognition 214 for words using natural language processing techniques. In some embodiments, coherent units in a message are pre-processed by named entity recognition 214 before the message is used as a training example for training HAN 350, if used as a training example, and before the message is classified by HAN 350, if classified by HAN 350. Through pre-processing, common words and stop words may be removed. Stemming, normalization, or lemmatization may also be performed as part of pre-processing a coherent unit. For example, the coherent unit in a message such as “I came across your profile and think that your computer science background is a great fit for a software technical lead position located in Atlanta, Ga.” After pre-processing of the message by named entity recognition 214, the coherent unit may become “I came profile think [Skill] background great fit [Position] located [Location].” Thus, HAN 350 may be trained based on pre-processed forms of coherent units parsed from electronic messages.

In some implementations, when training HAN 350, the pre-processed form of a coherent unit only retains words that appear a threshold number of times in a set of messages used as training examples for training HAN 350. The threshold number may be between three and seven, for example. By doing so, the potential for overfitting by HAN 350 when classifying messages 216 is reduced.

### Wide and Deep Model

HAN 350 is useful for classifying messages 216 as either likely to be accepted or likely to be declined/ignored based on the text content of messages 216 themselves. However, messages 216 may have contextual metadata 226 pertaining to the senders and recipients of messages 216 in the particular vertical messaging context. This contextual metadata 226 is also useful for classifying messages 216 as likely to accepted or likely to be declined/ignored based on contextual metadata 226 of messages 216.

The contextual metadata about a message in set of messages 216 may include user features, environmental features, and vertical messaging context features. User features may include features about the sender and the recipient of the message (e.g., country, language, demographics, etc.). Environmental features may include features about the date or time the message was sent or received (e.g., hour of the day, day of the week, etc.) or the type of device or client computing platform used to receive the message (e.g., mobile, web, etc.). Vertical messaging context features may include features pertaining to the message that are specific to the particular vertical messaging context in which the message was sent and received. For example, if the particular vertical messaging context is recruiting, then the vertical messaging context features may include any of the following features, a subset of these features, or a superset thereof:
Features of the sender or the recipient of the message such as the sender's or recipient's experience, job title, current company, geographic location, and education.
Features of the recruiter/sender such as the company the recruiter works for and the industry recruited for.
Features of the unfilled employment position such as title, location, position, salary range, company, and industry.

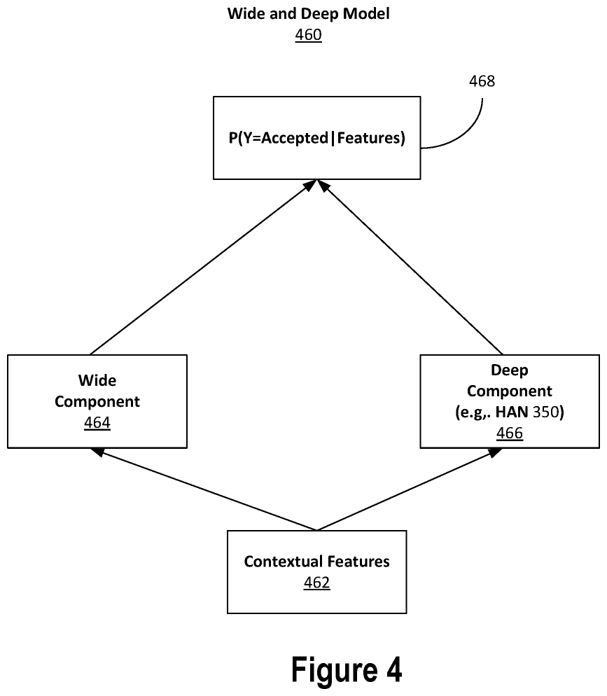

FIG. 4 depicts a wide and deep classifier 460 for classifying standard message as either likely to be accepted 220 or likely to be declined/ignored 222. Classifier 460 may be based on a wide and deep learning system. In particular, classifier 460 includes wide component 464 and deep component 466. In some implementations, deep component 466 is HAN 350. Wide component 464 may encompass a generalized linear model (GLM). The GLM may compute a prediction as a function of a vector of weighted contextual metadata features 462 about a message in standard messages 216 and a bias. The contextual metadata features 462 may include raw features and transformed features. For example, features can be transformed by the cross-product transformation to capture interactions between binary contextual metadata features for a message and to add nonlinearity to the GLM. Deep component 466 may be a neural network such as HAN 350. Sparse, high-dimensional categorical contextual metadata features can be converted into a low-dimensional and dense real-valued vector (i.e., an embedding vector). The dimensionality of the embedding can be on the order of ten to 100. During training, embedding vectors can be initialized randomly and then the values of the embedding vectors are trained to minimize a loss function. The low-dimensional vectors can be fed into the hidden layers of the feed forward neural network in a forward pass. The activation functions can be rectified linear units (ReLUs) or other suitable activation function units.

Classifier 460 includes wide component 464 and deep component 466 can be jointly trained. The outputs of wide component 464 and deep component 466 can be combined using a weighted sum of their output log odds prediction (classification) which can then be fed to one common logistic loss function for joint training. Joint training of classifier 460 can be done by backpropagating the gradients from the output to both the wide component 464 and deep component 466 simultaneously using mini-batch optimization. In an implementation, the Follow-the-Regularized-Leader (FTRL) algorithm with L1 regularization is used as the optimizer for wide component 464 and AdaGrad is used as the optimizer for deep component 466. Classifier 460 may be trained with contextual metadata features for a set of standard messages (not shown). Each training example may be labeled as likely to be accepted (1) or likely to be declined/ignored.

Scoring pipeline 210 determines and stores salient units 224. Salient units 224 are determined from likely to be accepted messages 220 based on the attention scores of coherent units in messages 220. Classifier 218 determines likely to be accepted messages 220 with attention scores and likely to be decline/ignored messages 220 from standard messages 216. Named entity recognition generates standard messages 216 from electronic messages 212 by identifying and replacing certain named entities in messages 212 with categorical named entity placeholders.

### Inference Pipeline

Referring now to FIG. 2B, it depicts inference pipeline 230. Given incomplete electronic message 232, inference pipeline 230 can suggest one or more coherent units 244 for inclusion in incomplete message 232. Incomplete electronic message 232 is an electronic message being composed by a user in a vertical messaging context. Coherent unit(s) 244 can be suggested to the user composing incomplete message 232. For example, coherent unit(s) 244 can be suggested to the user in the manner depicted in FIGS. 1A-1K and described above.

In operation, incomplete message 232 is input to named entity recognition 214 to produce an incomplete standard message 236. Incomplete standard message 236 contains the coherent units of incomplete message 232 but in standard form (i.e., standard units) with certain named entities replaced by categorical named entity placeholders. In addition, named entity recognition 214 may preprocess coherent units in the manner described above in anticipation of being input to salient unit selection and ordering 238. Such preprocessing may include removing stop words, lemmatization, stemming, etc., as described above with respect to scoring pipeline 210.

Salient unit selection and ordering 238 encompasses a learned scoring function that maps a pair of incomplete standard message 236 and a candidate salient unit of salient units 224 to a score. The function is learned such that relevant pairs have high scores, and irrelevant pairs have low scores. In an implementation, the learned scoring function has a two-tower structure. Multiple candidate salient units of salient units 224 can be evaluated this way and one or more of the top scoring salient units can selected to be suggested to the user for income message 232.

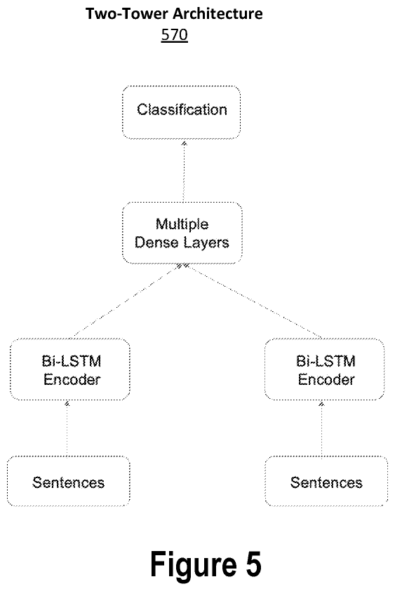

Each of the two towers are based on an artificial neural network. One tower generates an embedding (i.e., a vector of real numbers) of incomplete standard message 236 and the other tower produces an embedding of the candidate salient unit. FIG. 5 depicts two-two model 570. Specifically, given incomplete standard message 236 and a candidate salient unit, model 570 includes two encoder functions that each map a sequence of coherent units to their associated embeddings. One embedding for the standard unit(s) of incomplete standard message 236 and another embedding the candidate salient unit. The score may be determined as the inner product (e.g., cosine similarity) of the two embeddings.

Two-tower model 570 can efficiently score many candidate salient units for incomplete standard message 236. This efficiency is realized because the embeddings for salient units 224 can be pre-computed using two-tower model 570 before inference pipeline 230 is applied to incomplete standard messages such as incomplete standard message 236. As a result of this pre-computation, given incomplete standard message 236 at inference time, only an embedding for incomplete standard message 236 needs to be computed using two-tower model 570 and candidate salient units can be efficiently scored by computing the inner product of the embedding generated for incomplete standard message 236 and each of the precomputed embeddings for the candidate salient units. In this way, a score can be generated for incomplete standard message 236 and each of the candidate salient units. One or more of the top scoring candidate salient units can be selected to be suggested to the user. Two-tower model 570 can be trained on a training data set that includes representations (e.g., embeddings) of incomplete standard message and candidate salient unit pairs with associated positive or negative labels.

During inference, one or more ordered salient units 240 are produced by salient unit selection and ordering 238 for incomplete standard message 236. Each of the one or more ordered salient units 240 is one of the salient units 224. The salient units 240 are ordered according to their scores generated by salient unit selection and ordering 238 in order of highest score unit to lowest scoring unit. If the highest scoring unit of salient units 240 is not above a minimum score threshold, then inference pipeline 230 may decide not to suggest any coherent units to the user for incomplete message 232. Likewise, inference pipeline 230 may decide to suggest only those of ordered salient units 240 that are above the minimum score threshold, or only a predetermined number (e.g., 1, 3, 4, 5, etc.) of those of ordered salient units 240 that are above the minimum score threshold.

If an ordered salient unit of ordered salient unit(s) 240 contains one or more categorical named entity placeholders, then the placeholders in the ordered salient unit may be replaced by placeholder substitution 242 with named entities from contextual metadata 226 for incomplete electronic message 232. For example, placeholder substitution 242 can replace the placeholder “[industry]” in the ordered salient unit “I am a recruiter for the [Industry]” with the appropriate named entity (e.g., “software industry” or “construction industry”) from contextual metadata 226 for the user composing incomplete message 232 before being suggested to the user as one of coherent unit(s) 244.

Inference pipeline 230 can repeat the operations described above for different incomplete messages and different users in the particular vertical messaging context to suggest ordered coherent unit(s) for the different incomplete messages.

### Cloud Computing

The disclosed techniques can be implemented in a “cloud computing” environment. The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the public. In contrast, a private cloud environment is generally intended solely for use by, or within, a single organization. A community cloud is intended to be shared by several organizations within a community; while a hybrid cloud comprises two or more types of cloud (e.g., private, community, or public) that are bound together by data and application portability.

Generally, a cloud computing model enables some of those responsibilities which previously might have been provided by an organization's own information technology department, to instead be delivered as service layers within a cloud environment, for use by consumers (either within or external to the organization, according to the cloud's public/private nature). Depending on the implementation at hand, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (e.g., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (e.g., everything below the operating system layer).

### Basic Computing Device

The disclosed techniques can be implemented by one or more computing devices. If by more than one computing device, the disclosed techniques can be implemented in whole or in part using a combination of computing devices that are coupled together intermittently, periodically, or continuously by a data communications network or data communications bus in a distributed, federated, parallel, or other multi-computing device computing system.

A computing device used in an implementation of the disclosed techniques can be hard-wired to perform some or all of the disclosed techniques, or can include digital electronic devices such as at least one application-specific integrated circuit (ASIC) or field programmable gate array (FPGA) that is persistently programmed to perform some or all of the disclosed techniques, or can include at least one general purpose hardware processor programmed to perform some or all the disclosed techniques pursuant to program instructions in firmware, memory, other storage, or a combination. A computing device used in an implementation of the disclosed techniques can also combine custom hard-wired logic, ASICs, or FPGAs with custom programming to accomplish some or all the disclosed techniques. A computing device used in an implementation of the disclosed techniques can be a server computing device, a workstation computing device, a personal computing device, a portable computing device, a handheld computing device, a mobile computing device or any other computing device that incorporates hard-wired or program logic to implement some or all the disclosed techniques.

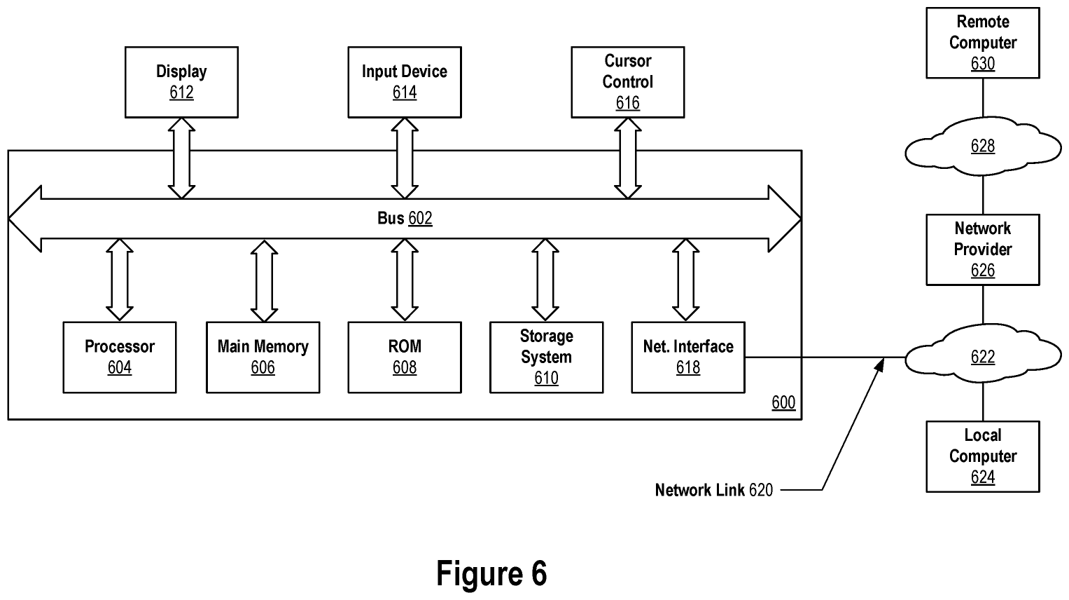

FIG. 6 is a block diagram of an example basic computing device for use in an implementation of the disclosed techniques. In the example of FIG. 6, computing device 600 and instructions for implementing some or all the disclosed techniques in hardware, software, or a combination of hardware and software, are represented schematically, for example as boxes and circles, at the same level of detail that is commonly used by persons of ordinary skill in the art to which this disclosure pertains for communicating about computer architecture and computing device implementations.

Computing device 600 includes an input/output (I/O) subsystem 602 which can include a bus or other communication mechanism for communicating information or instructions between the components of the computing device 600 over electronic signal paths. The I/O subsystem 602 can include an I/O controller, a memory controller and at least one I/O port. The electronic signal paths are represented schematically in the drawings, for example as lines, unidirectional arrows, or bidirectional arrows.

At least one hardware processor 604 is coupled to I/O subsystem 602 for processing information and instructions. Hardware processor 604 can include, for example, a general-purpose microprocessor or microcontroller or a special-purpose microprocessor such as an embedded system or a graphics processing unit (GPU) or a digital signal processor or ARM processor. Processor 604 can comprise an integrated arithmetic logic unit (ALU) or can be coupled to a separate ALU.

Computing device 600 includes one or more units of memory 606, such as a main memory, which is coupled to I/O subsystem 602 for electronically digitally storing data and instructions to be executed by processor 604. Memory 606 can include volatile memory such as various forms of random-access memory (RAM) or other dynamic storage device. Memory 606 also can be used for storing temporary variables or other intermediate information during execution of instructions to be executed by processor 604. Such instructions, when stored in non-transitory storage media accessible to processor 604, can render computing device 600 into a special-purpose machine that is customized to perform the operations specified in the instructions.

Computing device 600 further includes non-volatile memory such as read only memory (ROM) 608 or other static storage device coupled to I/O subsystem 602 for storing information and instructions for processor 604. The ROM 608 can include various forms of programmable ROM (PROM) such as erasable PROM (EPROM) or electrically erasable PROM (EEPROM). A unit of persistent storage 610 can include various forms of non-volatile RAM (NVRAM), such as FLASH memory, or solid-state storage, magnetic disk or optical disk such as CD-ROM or DVD-ROM and can be coupled to I/O subsystem 602 for storing information and instructions. Storage 610 is an example of a non-transitory computer-readable medium that can be used to store instructions and data which when executed by the processor 604 cause performing computer-implemented methods to execute some or all the disclosed techniques.

The instructions in memory 606, ROM 608 or storage 610 can comprise one or more sets of instructions that are organized as modules, methods, objects, functions, routines, or calls. The instructions can be organized as one or more computer programs, operating system services or application programs including mobile apps. The instructions can comprise an operating system or system software; one or more libraries to support multimedia, programming or other functions; data protocol instructions or stacks to implement TCP/IP, HTTP or other communication protocols; file processing instructions to interpret and render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions can implement a web server, web application server or web client. The instructions can be organized as a presentation layer, application layer and data storage layer such as a database system using structured query language (SQL) or NoSQL, an object store, a graph database, a flat file system or other data storage.

Computing device 600 can be coupled via I/O subsystem 602 to at least one output device 612. Output device 612 can be a digital computer display. Examples of a display that can be used include a touch screen display or a light-emitting diode (LED) display or a liquid crystal display (LCD) or an e-paper display. Computing device 600 can include other types of output devices 612, alternatively or in addition to a display device. Examples of other output devices 612 include printers, ticket printers, plotters, projectors, sound cards or video cards, speakers, buzzers or piezoelectric devices or other audible devices, lamps or LED or LCD indicators, haptic devices, actuators, or servos.

An input device 614 can be coupled to I/O subsystem 602 for communicating signals, data, command selections or gestures to processor 604. Examples of input devices 614 include touch screens, microphones, still and video digital cameras, alphanumeric and other keys, keypads, keyboards, graphics tablets, image scanners, joysticks, clocks, switches, buttons, dials, slides, or various types of sensors such as force sensors, motion sensors, heat sensors, accelerometers, gyroscopes, and inertial measurement unit (IMU) sensors or various types of transceivers such as wireless, such as cellular or Wi-Fi, radio frequency (RF) or infrared (IR) transceivers and Global Positioning System (GPS) transceivers.

Another type of input device is a control device 616, which can perform cursor control or other automated control functions such as navigation in a graphical interface on a display screen, alternatively or in addition to input functions. Control device 616 can be a touchpad, a mouse, a trackball, or cursor direction keys for communicating direction information and command selections to processor 604 and for controlling cursor movement on display 612. The input device can have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 614 can include a combination of multiple different input devices, such as a video camera and a depth sensor.

Computing device 600 can comprise an internet of things (IoT) device or other computing appliance in which one or more of output device 612, input device 614, and control device 616 are omitted. The input device 614 can comprise one or more cameras, motion detectors, thermometers, microphones, seismic detectors, other sensors or detectors, measurement devices or encoders and the output device 612 can comprise a special-purpose display such as a single-line LED or LCD display, one or more indicators, a display panel, a meter, a valve, a solenoid, an actuator, or a servo.

When computing device 600 is a mobile or portable computing device, input device 614 can comprise a global positioning system (GPS) receiver coupled to a GPS module that is capable of triangulating to a plurality of GPS satellites, determining and generating geo-location or position data such as latitude-longitude values for a geophysical location of the computing device 600. Output device 612 can include hardware, software, firmware, and interfaces for generating position reporting packets, notifications, pulse or heartbeat signals, or other recurring data transmissions that specify a position of the computing device 600, alone or in combination with other application-specific data, directed toward host 624 or server 630.

Computing device 600 can implement some or all the disclosed techniques using customized hard-wired logic, at least one ASIC or FPGA, firmware or program instructions or logic which when loaded and used or executed in combination with computing device 600 causes or programs computing device 600 to operate as a special-purpose machine.

Disclosed techniques performed by computing device 600 can be performed in response to processor 604 executing at least one sequence of at least one instruction contained in main memory 606. Such instructions can be read into main memory 606 from another storage medium, such as storage 610. Execution of the sequences of instructions contained in main memory 606 causes processor 604 to perform some or all the disclosed techniques. Hard-wired circuitry can be used in place of or in combination with software instructions.

The term “storage media” as used herein refers to any non-transitory computer-readable media that store data or instructions that cause a machine to operation in a specific fashion. Such storage media can comprise non-volatile media or volatile media. Non-volatile media includes, for example, optical or magnetic disks, such as storage 610. Volatile media includes dynamic memory, such as memory 606. Common forms of storage media include, for example, a hard disk, solid state drive, flash drive, magnetic data storage medium, any optical or physical data storage medium, memory chip or the like.

Storage media is distinct from but can be used in conjunction with transmission media. Transmission media participates in transferring information between storage media. For example, transmission media includes coaxial cables, copper wire and fiber optics, including the wires that comprise a bus of I/O subsystem 602. Transmission media can also take the form of acoustic or light waves, such as those generated during radio-wave and infra-red data communications.

Various forms of media can be involved in carrying at least one sequence of at least one instruction to processor 604 for execution. For example, the instructions can initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computing device 600 can receive the data on the communication link and convert the data to be read by computing device 600. For instance, a receiver such as a radio frequency antenna or an infrared detector can receive the data carried in a wireless or optical signal and appropriate circuitry can provide the data to I/O subsystem 602 such as place the data on a bus. I/O subsystem 602 carries the data to memory 606, from which processor 604 retrieves and executes the instructions. The instructions received by memory 606 can optionally be stored on storage 610 either before or after execution by processor 604.

Computing device 600 also includes a communication interface 618 coupled to bus 602. Communication interface 618 provides a two-way data communication coupling to network link 620 that is directly or indirectly connected to at least one communication networks, such as a network 622 or a public or private cloud on the Internet. For example, communication interface 618 can be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 622 broadly represents a local area network (LAN), wide-area network (WAN), campus network, internetwork, or any combination thereof. Communication interface 618 can comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 618 sends and receives electrical, electromagnetic, or optical signals over signal paths that carry digital data streams representing various types of information.

Network link 620 typically provides electrical, electromagnetic, or optical data communication directly or through at least one network to other data devices, using, for example, satellite, cellular, Wi-Fi, or BLUETOOTH technology. For example, network link 620 can provide a connection through a network 622 to a host computer 624.

Furthermore, network link 620 can provide a connection through network 622 or to other computing devices via internetworking devices and/or computers that are operated by an Internet Service Provider (ISP) 626. ISP 626 provides data communication services through a world-wide packet data communication network represented as internet 628. A server computer 630 can be coupled to internet 628. Server 630 broadly represents any computer, data center, virtual machine, or virtual computing instance with or without a hypervisor, or computer executing a containerized program system such as DOCKER or KUBERNETES. Server 630 can represent an electronic digital service that is implemented using more than one computer or instance and that is accessed and used by transmitting web services requests, uniform resource locator (URL) strings with parameters in HTTP payloads, API calls, app services calls, or other service calls.

Computing device 600 and server 630 can form elements of a distributed computing system that includes other computers, a processing cluster, server farm or other organization of computers that cooperate to perform tasks or execute applications or services. Server 630 can comprise one or more sets of instructions that are organized as modules, methods, objects, functions, routines, or calls. The instructions can be organized as one or more computer programs, operating system services, or application programs including mobile apps. The instructions can comprise an operating system and/or system software; one or more libraries to support multimedia, programming or other functions; data protocol instructions or stacks to implement TCP/IP, HTTP or other communication protocols; file format processing instructions to interpret or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 630 can comprise a web application server that hosts a presentation layer, application layer and data storage layer such as a database system using structured query language (SQL) or NoSQL, an object store, a graph database, a flat file system or other data storage.

Computing device 600 can send messages and receive data and instructions, including program code, through a network, network link 620 and communication interface 618. In the Internet example, server 630 might transmit a requested code for an application program through Internet 628, ISP 626, local network 622 and communication interface 618. The received code can be executed by processor 604 as it is received, or stored in storage 610, or other non-volatile storage for later execution.

### Basic Software System

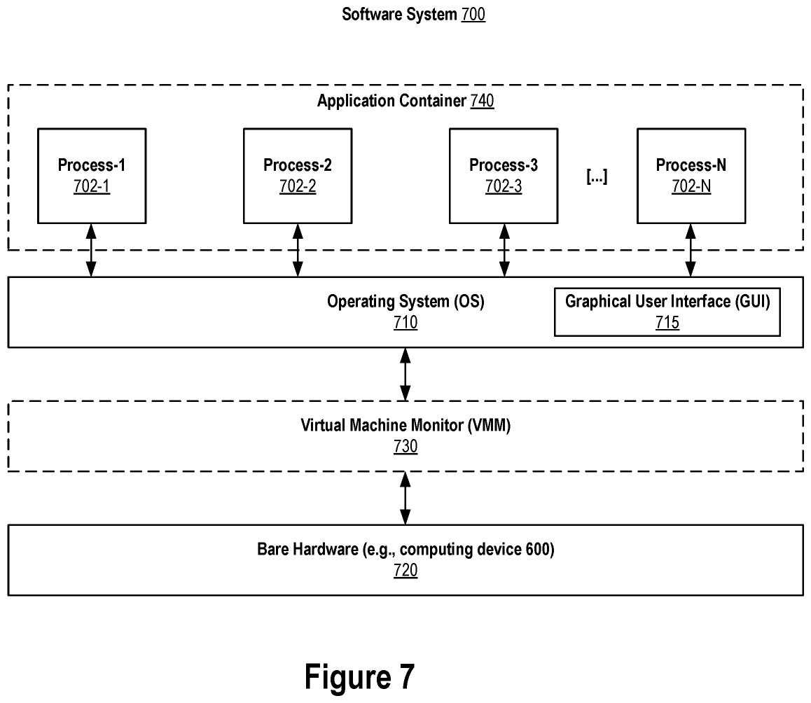

FIG. 7 is a block diagram of an example basic software system 700 that can be employed for controlling the operation of computing device 600 of FIG. 6. Software system 700 and its components, including their connections, relationships, and functions, is meant to be an example only, and not meant to limit implementations of the disclosed techniques. Other software systems suitable for implementing the disclosed techniques can have different components, including components with different connections, relationships, and functions.

Software system 700 is provided for directing the operation of computer system 600. Software system 700, which can be stored in system memory (RAM) 606 and on fixed storage (e.g., hard disk or flash memory) 610, includes a kernel or operating system (OS) 710.

OS 710 manages low-level aspects of computer operation, including managing execution of processes, represented as 702-1, 702-2, 702-3 . . . 702-N, memory allocation, file input and output (I/O) and device I/O. One or more application programs can be “loaded” (e.g., transferred from fixed storage 610 into memory 606) for execution as one or more processes by the system 700. The applications or other software intended for use on computing device 600 can also be stored as a set of downloadable computer-executable instructions, for example, for downloading and installation from an Internet location (e.g., a Web server, an app store or other online service).

The execution of application program instructions can implement a process (e.g., 702-2) in the form of an instance of a computer program that is being executed and consisting of program code and its current activity. Depending on the operating system (OS), a process (e.g., 702-3) can be made up of multiple threads of execution that execute instructions concurrently. In this context, a computer program is a passive collection of instructions, while a process (e.g., 702-1) can be the actual execution of those instructions. Several processes (e.g., 702-1 and 702-2) can be associated with the same program; for example, opening several instances of the same program often means more than one process is being executed, or a program that initially launches as a single process can subsequently spawn (e.g., fork) additional processes.

OS 710 can implement multitasking to allow processes 702-1, 702-2, 702-3 . . . 702-N to share processor 604. While each processor 604 or core of the processor executes a single task at a time, computing device 600 can be programmed to implement multitasking to allow each processor to switch between tasks that are being executed without having to wait for each task to finish. Switches can be performed when tasks perform input/output operations, when a task indicates that it can be switched, or on hardware interrupts. Time-sharing can be implemented to allow fast response for interactive user applications by rapidly performing context switches to provide the appearance of concurrent execution of multiple processes simultaneously. For security and reliability, OS 710 can prevent direct communication between independent processes, providing strictly mediated and controlled inter-process communication functionality.

In some instances, processes 702-1, 702-2, 702-3 . . . 702-N and the application programs they implement can execute within application container 740. Application containers generally are a mode of operation of OS 710 in which OS 710 allows the existence of multiple isolated user space instances to run on OS 710. Application container 740 is an example of one such instance. The instances themselves are sometimes alternatively referred to as zones, virtual private servers, partitions, virtual environments, virtual kernels, or jails. Application containers provide a mechanism whereby finite hardware computing resources such as CPU time and storage media space can be allocated among the instances.

Software system 700 includes a graphical user interface (GUI) 715, for receiving user commands and data in a graphical (e.g., “point-and-click” or “touch gesture”) fashion. These inputs, in turn, can be acted upon by system 700 in accordance with instructions from operating system 710 or processes 702-1, 702-2, 702-3 . . . 702-N. GUI 715 also serves to display the results of operation from OS 710 and processes 702-1, 702-2, 702-3 . . . 702-N, whereupon the user can supply additional inputs or terminate the session (e.g., log off).

OS 710 can execute directly on bare hardware 720 (e.g., processor 604) of computing device 600. Alternatively, a hypervisor or virtual machine monitor (VMM) 730 can be interposed between bare hardware 720 and OS 710. In this configuration, VMM 730 acts as a software “cushion” or virtualization layer between OS 710 and bare hardware 720 of computing device 600.

VMM 730 instantiates and runs one or more virtual machine instances (“guest machines”). Each guest machine comprises a “guest” operating system, such as OS 710, and one or more applications, such as applications 702, designed to execute on the guest operating system. VMM 730 presents the guest operating systems with a virtual operating platform and manages the execution of the guest operating systems.

In some instances, VMM 730 can allow a guest operating system to run as if it is running on bare hardware 720 of computing device 600 directly. In these instances, the same version of the guest operating system configured to execute on the bare hardware 720 directly can also execute on VMM 730 without modification or reconfiguration. In other words, VMM 730 can provide full hardware and CPU virtualization to a guest operating system in some instances.

In other instances, a guest operating system can be specially designed or configured to execute on VMM 730. In these instances, the guest operating system is “aware” that it executes on a virtual machine monitor. In other words, VMM 730 can provide para-virtualization to a guest operating system in some instances.

### Other Aspects of the Disclosure

Unless the context clearly indicates otherwise, the term “or” is used in the foregoing specification and in the appended claims in its inclusive sense (and not in its exclusive sense) so that when used, for example, to connect a list of elements, the term “or” means one, some, or all the elements in the list.

Unless the context clearly indicates otherwise, the terms “comprising,” “including,” “having,” “based on,” “encompassing,” and the like, are used in the foregoing specification and in the appended claims in an open-ended fashion, and do not exclude additional elements, features, acts, or operations.

Unless the context clearly indicates otherwise, conjunctive language such as the phrase “at least one of X, Y, and Z,” is to be understood to convey that an item, term, etc. can be either X, Y, or Z, or a combination thereof. Thus, such conjunctive language is not intended to require by default implication that at least one of X, at least one of Y and at least one of Z to each be present.

Unless the context clearly indicates otherwise, as used in the foregoing detailed description and in the appended claims, the singular forms “a,” “an,” and “the” are intended to include the plural forms as well.

Unless the context clearly indicates otherwise, in the foregoing detailed description and in the appended claims, although the terms first, second, etc. are, in some instances, used herein to describe various elements, these elements should not be limited by these terms. These terms are only used to distinguish one element from another. For example, a first computing device could be termed a second computing device, and, similarly, a second computing device could be termed a first computing device. The first computing device and the second computing device are both computing devices, but they are not the same computing device.

In the foregoing specification, the disclosed techniques have been described with reference to numerous specific details that can vary from implementation to implementation. The specification and drawings are, accordingly, to be regarded in an illustrative rather than a restrictive sense.

1. A method comprising:
causing a computer graphical user interface to present a suggestion of one or more coherent text units for insertion at a current text input cursor location within a body of an electronic message being composed, each coherent text unit of the one or more coherent text units being a sentence or a clause;
wherein the one or more coherent text units are determined based on:
using a hierarchical attention network to classify each electronic message in a set of electronic messages as either likely to be accepted or likely to be declined/ignored based on text content of the electronic message;
determining a set of candidate coherent text units based on electronic messages of the set of electronic messages classified by the hierarchical attention network as likely to be accepted;
selecting one or more candidate coherent text units from the set of candidate coherent text units; and
determining the one or more coherent text units based on the one or more candidate coherent text units.

2. The method of claim 1, further comprising:
determining the set of candidate coherent text units based on attention scores generated for the set of candidate coherent text units by the hierarchical attention network.

3. The method of claim 1, further comprising:
using a wide and deep model to classify each electronic message in the set of electronic messages as either likely to be accepted or likely to be declined/ignored based on contextual metadata associated with the electronic message being composed, the wide and deep model comprising a deep component, the deep component comprising the hierarchical attention network; and
determining the set of candidate coherent text units based on electronic messages of the set of electronic messages classified by the wide and deep model as likely to be accepted.

4. The method of claim 1, further comprising:
forming a particular coherent text unit of the one or more coherent text units based on replacing a categorical named entity placeholder in a candidate coherent text unit with a named entity obtained from contextual metadata associated with the electronic message being composed.

5. The method of claim 1, further comprising:
determining the one or more coherent text units based on a current text content of the electronic message being composed.

6. The method of claim 1, wherein each electronic message in the set of electronic messages classified by the hierarchical attention network is a standard message.

7. The method of claim 1, further comprising:
computing a respective inner product for each candidate coherent text unit of the set of candidate coherent text units, the respective inner product computed based on an embedding representing a current text content of the electronic message being composed and a precomputed embedding for the candidate coherent text unit; and
selecting the one or more candidate coherent text units from the set of candidate coherent text units from the respective inner products computed.

8. The method of claim 1, further comprising:
training a two-tower artificial neural network based on a training data set comprising representations of incomplete standard message and candidate salient unit pairs with associated positive or negative labels; and
selecting the one or more candidate coherent text units from the set of candidate coherent text units using the trained two-tower artificial neural network.

9. A non-transitory storage media storing instructions which, when executed by one or more computing devices, cause the one or more computing devices to perform:
causing a computer graphical user interface to present a suggestion of one or more coherent text units for insertion at a current text input cursor location within a body of an electronic message being composed, each coherent text unit of the one or more coherent text units being a sentence or a clause;
wherein the one or more coherent text units are determined based on:
using a wide and deep model to classify each electronic message in a set of electronic messages as either likely to be accepted or likely to be declined/ignored based on text content of the electronic message;
determining a set of candidate coherent text units based on electronic messages of the set of electronic messages classified by the wide and deep model as likely to be accepted; and
selecting one or more candidate coherent text units from the set of candidate coherent text units; and
determining the one or more coherent text units based on the one or more candidate coherent text units.

10. The non-transitory storage media of claim 9, further storing instructions which, when executed by the one or more computing devices, cause the one or more computing devices to perform:
determining the set of candidate coherent text units based on attention scores generated for the set of candidate coherent text units by the wide and deep model.

11. The non-transitory storage media of claim 9, further storing instructions which, when executed by the one or more computing devices, cause the one or more computing devices to perform:
forming a particular coherent text unit of the one or more coherent text units based on replacing a categorical named entity placeholder in a corresponding candidate coherent text unit with a named entity obtained from contextual metadata associated with the electronic message being composed.

12. The non-transitory storage media of claim 9, further storing instructions which, when executed by the one or more computing devices, cause the one or more computing devices to perform:
determining the one or more coherent text units based on a current text content of the electronic message being composed.

13. The non-transitory storage media of claim 9, where each electronic message in the set of electronic messages classified by the wide and deep model is a standard message.

14. The non-transitory storage media of claim 9, further storing instructions which, when executed by the one or more computing devices, cause the one or more computing devices to perform:
computing a respective inner product for each candidate coherent text unit of the set of candidate coherent text units, the respective inner product computed based on an embedding representing a current text content of the electronic message being composed and a precomputed embedding for the candidate coherent text unit; and
selecting the one or more candidate coherent text units from the set of candidate coherent text units from the respective inner products computed.

15. The non-transitory storage media of claim 9, further comprising:
training a two-tower artificial neural network based on a training data set comprising representations of incomplete standard message and candidate salient unit pairs with associated positive or negative labels; and
selecting the one or more candidate coherent text units from the set of candidate coherent text units using the trained two-tower artificial neural network.

16. A computing system comprising:
one or more processors;
storage media; and
instructions stored in the storage media and which, when executed by the one or more processors, cause the computing system to perform:
suggesting in a computer graphical user interface a coherent text unit for insertion at a current text input cursor location within a body of an electronic message being composed, the coherent text unit being a sentence or a clause;
wherein the coherent text unit is determined based on:
determining a set of candidate standard text units based on electronic messages of a set of electronic messages classified as likely to be accepted, each electronic message of the set of electronic messages comprising text content;
selecting a standard text unit from the set of candidate standard text units; and
forming the coherent text unit based on replacing one or more categorical named entity placeholders in the standard text unit with one or more corresponding named entities obtained from contextual metadata associated with the electronic message being composed.

17. The computing system of claim 16, further comprising instructions stored in the storage media and which, when executed by the one or more processors, cause the computing system to perform:
determining the set of candidate standard text units based on attention scores generated by a hierarchical attention network for the set of candidate standard text units.

18. The computing system of claim 16, further comprising instructions stored in the storage media and which, when executed by the one or more processors, cause the computing system to perform:
using a wide and deep model to classify the standard text unit as likely to be accepted.

19. The computing system of claim 16, further comprising instructions stored in the storage media and which, when executed by the one or more processors, cause the computing system to perform:
using a hierarchical attention network to classify the standard text unit as likely to be accepted.

20. The computing system of claim 16, further comprising instructions stored in the storage media and which, when executed by the one or more processors, cause the computing system to perform:
using a wide and deep model to classify the standard text unit as likely to be accepted, the wide and deep model comprising a wide component and a deep component, the wide component comprising a generalized linear model and the deep component comprising a hierarchical attention network.
